(19) United States
(12) Patent Application Publication
(10) Pub. No.: US 2010/0060393 A1
(43) Pub. Date: Mar. 11, 2010

(54) ELECTROMAGNETIC LINEAR ACTUATOR

(75) Inventors: Hyun Woo Joo, Cheongju-si (KR); Sung Jun Tak, Cheongju-si (KR); Jae Seop Ryu, Cheongju-si (KR); Jong Hyuk Lee, Cheongju-si (KR)

Correspondence Address: LEE, HONG, DEGERMAN, KANG & WAIMEY, 660 S. FIGUEROA STREET, Suite 2300, LOS ANGELES, CA, 90017, US

(73) Assignee: LS INDUSTRIAL SYSTEMS CO., LTD.

(21) Appl. No.: 12/553,058

(22) Filed: Sep. 2, 2009

(30) Foreign Application Priority Data
Sep. 8, 2008 (KR) 10-2008-0088445

(51) Int. Cl. H01H 36/00

(52) U.S. Cl. 335/180

(57) ABSTRACT

An electromagnetic linear actuator is disclosed that is capable of providing a large driving force adequately used for a high-voltage circuit breaker due to simplified structure and reduced manufacturing cost, the actuator comprising: stators each facing the other about an axle; a mover disposed with a moving core and a moving coil wrapping the moving core to magnetize the moving core during conduction, and capable of linearly and axially moving an interior of the stator; and permanent magnets, one facing the other, and fixedly mounted on both inner walls of the stator for providing a Lorentz force and reluctance force to the moving coil for movement when a current flows in the moving coil of the mover, and for providing a holding force to the mover for holding a position when the electric conduction to the moving coil of the mover is interrupted.

### CROSS-REFERENCE TO RELATED APPLICATION

The present application is based on, and claims priority from, Korean Application Number 10-2008-0088445, filed Sep. 8, 2008, the disclosure of which is incorporated by reference herein in its entirety.

### BACKGROUND OF THE INVENTION

The present disclosure relates to an electromagnetic linear actuator, and more particularly, to an electromagnetic linear actuator capable of providing a large driving power adequately used for a low-voltage circuit breaker and high-voltage and super high-voltage circuit breakers as well.

### DESCRIPTION OF THE RELATED ART

An actuator providing a driving force to open or close a contact point, in a low-voltage circuit breaker for low voltage of several volts, and a high or super high-voltage circuit breaker for several kilo voltages or several hundred kilo voltages, may be generally categorized into two types, i.e., a spring type actuator receiving an opening/closing driving force by discharging a charged elastic energy to a spring, and a hydraulic and pneumatic actuator receiving the opening/closing driving force by using hydraulic and pneumatic pressure.

However, the spring type actuator may have various problems such as difficulty in obtaining operational reliability due to construction of providing the opening/closing driving force in association with many mechanical parts. The hydraulic and pneumatic actuator may also suffer from various problems such as difficulty in obtaining the operational reliability due to variation of the opening/closing driving force in response to temperature change.

Alternatively, a permanent magnet actuator (PMA) or an electromagnetic actuator (EMFA) has been proposed to replace the conventional spring type actuator and the hydraulic and pneumatic actuator.

FIGS. 1 and 2 illustrate exemplary embodiments of the permanent magnet actuator (PMA) and the electromagnetic actuator (EMFA) according to the prior art.

Referring to FIG. 1, construction of a permanent magnet actuator (PMA) will be described.

The PMA according to the conventional configuration may include a stator 2 comprised of one or two separate members each facing the other, and providing a movable space, a movable core 3 linearly moving in the movable space of the stator 2, first and second coil 4 and 5 each disposed at an inner end and at the other end of the stator 2 for providing an electromagnetic driving force for driving the movable core 3, a permanent magnet 6 for providing a magnetic holding force to the movable core 3 to thereby hold the position of the movable core 3, and supporting cores 7 and 8 for supporting the permanent magnet 6.

Unexplained reference numeral in FIG. 1 represents a movable axle connected at one end thereof to the movable core 3 and connected at the other end to a movable contact point directly or via a connection member.

Now, operation of the PMA according to the conventional configuration will be described.

Referring to FIG. 1 again, in a case a current is provided to the first coil 4 to magnetize the first coil 4, the movable core 3 comes to overcome the magnetic holding force of the permanent magnet 6 by way of the magnetic suction force from the magnetized first coil 4 and moves toward the first coil 4.

The upward movement of the movable core 3 may be utilized, for example, as a driving force for opening or closing movable contact points of a circuit connected via the movable axle 9.

Referring again to FIG. 1, in a case a current is provided to the second coil 5 to magnetize the second coil 5, the movable core 3 comes to overcome the magnetic holding force of the permanent magnet 6 by way of the magnetic suction force from the magnetized first coil 4 and moves toward the second coil 5.

The downward movement of the movable core 3 may be utilized, for example, as a driving force for opening or closing movable contact points of a circuit connected via the movable axle 9.

The abovementioned PMA according to the conventional technique uses only the electromagnetic force generated by the coil at the stator side to move the movable core to the advantage of simplifying the construction, reducing the manufacturing cost, and being used as a driving source of opening/closing of low-voltage circuit breaker.

However, the PMA according to the conventional technique may have various problems such as difficulty in application to high voltage or super high voltage circuit breaker due to requirement of input of large electric energy that calls for sufficient magnitude of magnetic field for driving the movable core in case a moving length of movable core is lengthened.

Now, configuration and operation of an electromagnetic actuator (EMFA) according to the conventional technique will be described with reference to FIG. 2.

Referring to FIG. 2, an EMFA may include a stator 11 formed with two external wall portions and an inner wall portion for providing a movable space between the inner wall portion and the external wall portions, a movable core 20 formed therein with a coil and being capable of linearly movable in the inner movable space of the stator 11, movable permanent magnets 30 and 40 each fixed at an external wall portion of the stator and at an upper mid lengthwise portion of the inner wall portion for providing the magnetic driving force for driving the movable core 20, position holding permanent magnets (50, 60; 55, 65) each fixed at the external wall portion of the stator 11 and both upper lengthwise distal ends of the inner wall portion for providing the magnetic holding force to the movable core 20 and allowing the movable core 20 to hold a position.

As illustrated in an enlarged perspective view inside the broken dotted lines of FIG. 2, the movable core 20 which is a member of a substantial “U” shape may include movable cores 22 and 24, and coils 21 and 23 provided between the movable cores 22 and 24, where the position holding permanent magnets (50, 60) out of the permanent magnets (50, 60; 55, 65), being positioned at an upper end of the stator 11, produce weaker magnetic force, compared with the position holding permanent magnets (55, 65) positioned at a lower end of the stator 11.

Therefore, in a case a current flows in the upper-located coil 21 to allow the coils 21 and 23 to form an electromagnetic field, the movable core 20 overcomes the magnetic holding force of the permanent magnets 55 and 65 according to a Lorentz force to move upwards on the drawing.

The upward movement of the movable core 20 in FIG. 2 may be utilized, for example, as a driving force for opening or closing a circuit of a movable contact point connected via the movable axle (not shown).

In a case the current flowing in the coils 21 and 23 is interrupted under the upward movement of the movable core 20, the magnetic force from the lower-positioned position holding permanent magnets 55 and 65 being stronger than that of the upper-positioned holding permanent magnets 50, 60, the movable core 20 is movably sucked downward of the stator 11 by the lower-positioned position holding permanent magnets 55 and 65 to hold the position thereof.

The linear movement upward or downward of the movable core 20 may be used as a driving force to open or close the movable core 20, i.e., a driving force to open or close a movable contact point of a circuit (not shown) connected to a movable axle.

The conventional actuator thus described may be advantageously used as an actuator for providing a driving force to open or close a high-voltage and super high-voltage circuit breaker that require a large power as the magnetic force by the movable permanent magnet and the electromagnetic force by the coil inside the movable core are combined to exercise a large driving force.

The conventional actuator thus described may be also advantageously used even if a moving distance of the movable core is lengthened due to linear configuration using the Lorentz force applied to the coil inside the movable core by the movable permanent magnet.

However, the conventional actuator may suffer from disadvantages in that manufacturing cost increases due to installation of many permanent magnets therein

### SUMMARY OF THE INVENTION

The present disclosure provides an electromagnetic linear actuator for use in a high-voltage circuit breaker or a super high-voltage circuit breaker capable of configuring a longer moving distance of a movable core, and simplifying structure thereof to reduce the manufacturing cost.

An electromagnetic linear actuator in accordance with the present disclosure comprises: stators each facing the other about an axle; a mover disposed with a moving core and a moving coil wrapping the moving core to magnetize the moving core during conduction, and capable of linearly and axially moving an interior of the stator; and permanent magnets, one facing the other, and fixedly mounted on both inner walls of the stator for providing a Lorentz force and reluctance force to the moving coil for movement when a current flows in the moving coil of the mover, and for providing a holding force to the mover for holding a position when the electric conduction to the moving coil of the mover is interrupted.

### BRIEF DESCRIPTION OF THE DRAWINGS

Reference will now be made in detail to the embodiments of the present disclosure, examples of which are illustrated in the accompanying drawings, wherein like reference numerals refer to the like elements throughout. The embodiments are described below in order to explain the present disclosure by referring to the figures. The present disclosure may, however, be embodied in many different forms and should not be construed as limited to the embodiments set forth herein. Rather, these embodiments are provided so that this disclosure will be thorough and complete, and will fully convey the scope of the general inventive concept to those skilled in the art.

FIG. 1 is a cross-sectional view illustrating a permanent magnet actuator according to prior art.

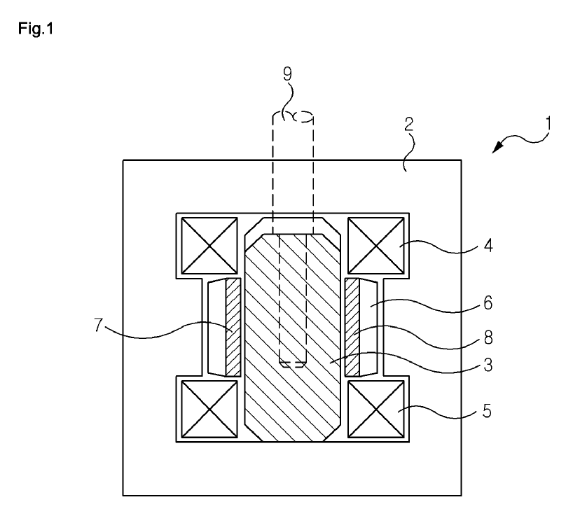

FIG. 2 is a perspective view illustrating an electromagnetic actuator according to prior art.

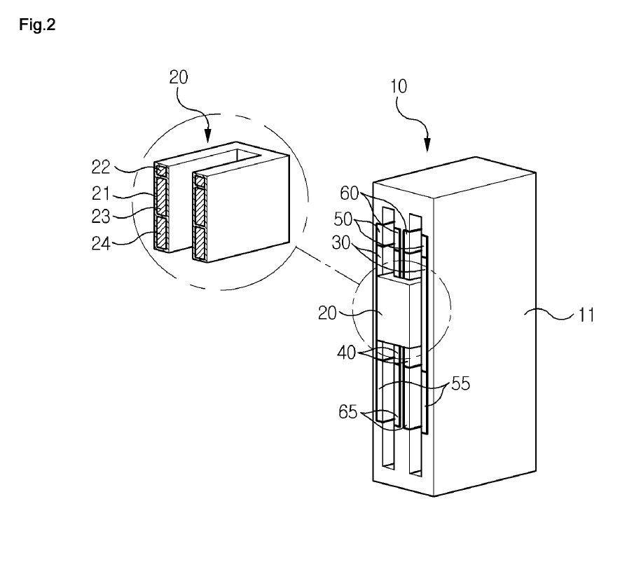

FIG. 3 is a schematic view illustrating an electromagnetic linear actuator according to an exemplary embodiment of the present disclosure.

FIG. 4 is a cross-sectional view illustrating a partial cross-section of FIG. 3.

### DETAILED DESCRIPTION OF THE INVENTION

The exemplary embodiments of the present disclosure will be described with reference to the accompanying drawings. The drawings are only exemplary to provide a general inventive concept and a principle of the present disclosure.

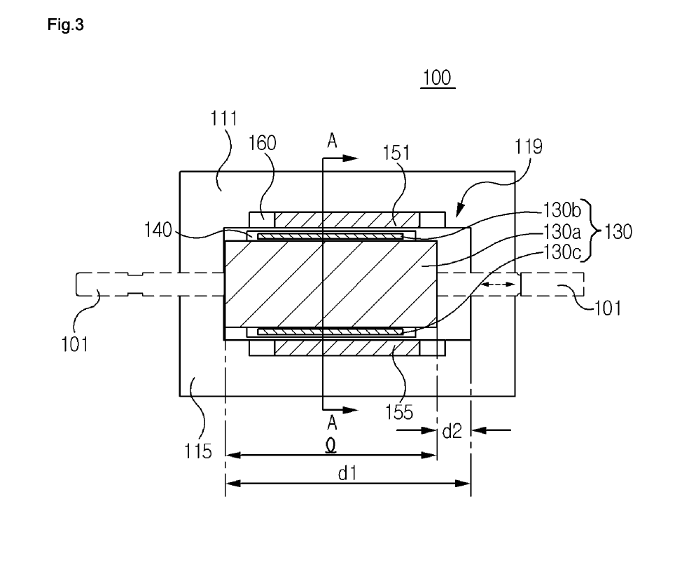

FIG. 3 is a schematic view illustrating an electromagnetic linear actuator according to an exemplary embodiment of the present disclosure.

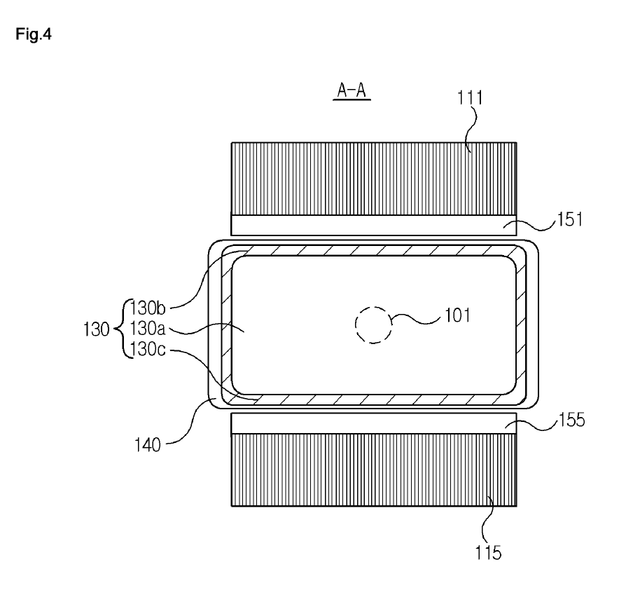

FIG. 4 is a cross-sectional view illustrating a cross-section of line “A-A” of FIG. 3.

As illustrated in the figures, an electromagnetic linear actuator 100 includes a pair of stators 111, 115, a mover 130 and permanent magnets 151, 155.

The stators (111, 115; yoke structure) may include a pair of stator cores, one facing the other, about an axle (101; rod), and the pair of stator cores may be separately mounted as illustrated in the exemplary embodiment, and may be integrated. Preferably, the stators 111, 115 are configured by axially stacking a plurality of stator plates for minimizing the eddy current that is induced.

The mover (130; armature) is linearly movable along an axle 101 disposed inside a space formed by and between the pair of the stators 111, 115. The mover 130 may include a movable core 130a, and movable coils (130b, 130c; actuating coils) wrapping the movable core 130a to magnetize the movable core 130a.

As illustrated in FIG. 4, the movable core 130a has a substantially rectangular cross-sectional shape about an axle 101. The movable core 130a may be stacked with thin plates in order to enhance the performance as the stators 111, 115. Furthermore, a molding portion 140 is formed on an external surface of the movable coils 130b, 130c in order to fix the movable coils 130b, 130c to the movable core 130a. The movable coils 130b, 130c are simultaneously moved by the molding portion 140.

The permanent magnets 151, 155, one facing the other, are fixedly mounted on both inner walls of the stator, with a distance including a width and a tolerance of the mover 130. The permanent magnets 151, 155 respectively fixed to the stators 111, 115 by a support 160 at both lateral walls. The permanent magnets 151, 155 provide a Lorentz force and reluctance force to the mover 130 for movement when a current flows in the moving coils 130b, 130c of the mover 130. The permanent magnets 151, 155 provide a holding force to the mover 130 for holding a position when the electric conduction to the moving coils 130b, 130c of the mover 130 is interrupted.

The electromagnetic force is generated by the Lorentz force generated by the movable coils 130b, 130c when a current flows in the movable coils 130b, 130c disposed inside the magnetic field of the permanent magnets 151, 155, where the electromagnetic linear actuator is mounted with a portion of the stators 111, 115 having a reluctance different from the reluctance of the movable core 130a inside the movable coils 130b, 130c when a current flows in the movable coils 130b, 130c in order to obtain a larger driving force. Henceforth, the portion is called a reluctance differentiating portion 119.

Referring to FIG. 3, the reluctance differentiating portion 119 is a portion having a thickness thicker than that of the other portion in the stators 111, 115.

In the exemplary embodiment, the reluctance differentiating portion 119 may be mounted at four different places in FIG. 3. The reluctance differentiating portion 119 may determine a moving distance of the mover 130 according to an axial length of the axle 101. That is, the moving distance (d2) of the mover 130 may be adjusted by adjustment of the length of the reluctance differentiating portion 119. To be more specific, the moving distance of the mover 130, as illustrated in FIG. 3, may be determined by a remaining distance except for a distance (d1) between two inner walls in the lengthwise direction of the stators 111, 115 and a distance (l) of the mover 130, and the distance (d2) of the reluctance differentiating portion 119.

Now, operation of the electromagnetic linear actuator thus configured will be described in the following.

Referring to FIG. 3, in a case when a current is made to flow in the movable coils 130b, 130c to allow the movable coils 130b, 130c to horizontally form a magnetic field, the magnetic field of the movable coils 130b, 130c and the magnetic field of the permanent magnets 151, 155 are combined. The mover 130 receives a Lorentz force in the right direction to generate an electromagnetic force in the right direction according to a difference between a magnetic resistance of the reluctance differentiating portion 119 and a magnetic resistance of the movable core 130a inside the movable coils 130b, 130c.

As a result, the mover 130 is moved toward the right direction from a position illustrated in FIG. 3 by the combined force between the Lorentz force and the electromagnetic force. The movement of the mover 130 to the right direction may be used, for example, as a driving force to open or close the circuit by being applied to a movable contact point (not shown) connected via the movable axle (101; rod). Under the circumstance where the mover is moved to the right direction, the magnetic field from the permanent magnets 151, 155 act the role of, not driving the mover 130, but holding the position to which the mover 130 has been moved.

In a case the current to the movable coils 130b, 130c is stopped, the mover 130 is moved to the left by the magnetic force of the permanent magnets 151, 155 to hold the position according to the permanent magnets 151, 155, as shown in FIG. 3.

As apparent from the foregoing, the electromagnetic linear actuator according to the present invention has an advantage in that permanent magnets can be minimally used to simplify the configuration and to reduce the manufacturing cost, because the permanent magnets can be dually used for driving (moving) the mover and for holding the position of the mover as well.

There is another advantage in that a driving force of the mover can be maximized by the combined force between the Lorentz force and the electromagnetic force, where a stator can minimize the eddy current that is induced because the stator is configured by axially laminating a plurality of stator plates.

There is still another advantage in the electromagnetic linear actuator according to the present invention in that the driving force can be maximized because the driving force is generated by the combined force between the Lorentz force and the electromagnetic force, enabling the actuator to be used for high voltage circuit breakers and super high voltage circuit breakers.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes.

What is claimed is:

1. An electromagnetic linear actuator, comprising:
stators each facing the other about an axle;
a mover disposed with a moving core and a moving coil wrapping the moving core to magnetize the moving core when a current flows, and capable of linearly and axially moving an interior of the stator; and
permanent magnets, one facing the other, and fixedly mounted on both inner walls of the stator for providing a Lorentz force and reluctance force to the moving coil for movement when a current flows in the moving coil of the mover, and for providing a holding force to the mover for holding a position when the current to the moving coil of the mover is interrupted.

2. The actuator of claim 1, wherein the stators are mounted with reluctance differentiating portions each having a different reluctance from that of the movable core when a current flows in the movable coil.

3. The actuator of claim 2, wherein the reluctance differentiating portion is a portion by which a moving distance of the mover can be determined by a length in the axial direction.

4. The actuator of claim 2, wherein a thickness of the reluctance differentiating portion is thicker than that of the other portion in the stator.

5. The actuator of claim 1, wherein the stator is axially laminated by a plurality of stator plates to minimize an induced eddy current.

6. The actuator of claim 1, wherein the movable core has a rectangular shape in its vertical cross-section about an axle.

7. The actuator of claim 1, comprising a molding portion formed on an external surface of the movable coil for fixing the movable coils to the movable core.
